(19) United States
(12) Patent Application Publication
(10) Pub. No.: US 2012/0104745 A1
(43) Pub. Date: May 3, 2012

(54) EXHAUST COUPLER FOR TURBOCHARGER AND EXTERNAL WASTEGATE

(76) Inventor: CHARLES BRAD STORY, Liberty, UT (US)

(21) Appl. No.: 12/914,096

(22) Filed: Oct. 28, 2010

(51) Int. Cl. F16L 41/00

(52) U.S. Cl. 285/133.11

(57) ABSTRACT

The present invention relates to a device for connecting a main exhaust line to the exhaust inlet of a turbocharger and for directing a portion of that exhaust towards an external wastegate in such a way that the turbulence of the exhaust flowing into the turbocharger is not substantially altered when exhaust flow is or is not being directed towards the wastegate.

### FIELD OF THE INVENTION

The present invention relates to a device for connecting a main exhaust line to the exhaust inlet of a turbocharger and for directing a portion of that exhaust towards an external wastegate in such a way that the turbulence of the exhaust flowing into the turbocharger is not substantially altered when exhaust flow is or is not being directed towards the wastegate.

### BACKGROUND OF THE INVENTION

Internal combustion engines rely on the ignition of a mixture of combustible fuel and oxygen to produce a positive pressure inside a cylinder housing a movable piston. In order for there to be a constant supply of fuel and oxygen, air must be drawn into the cylinder during part of the engine cycle. Typically, the upward motion of the piston creates a vacuum within the cylinder forcing air to be drawn into the cylinder from the ambient air outside the engine. Ambient air at sea level has a pressure of ˜1 atm which, at lower rpms, causes a sufficient pressure differential at the intake manifold of the engine to allow for an adequate air supply into the cylinder. At higher rpms, however, the ambient air pressure of ˜1 atm is often too low to allow for an adequate air supply into the cylinder within the timescale of each engine cycle. As a result, the performance and/or efficiency of the engine can be compromised.

To compensate for this effect, turbochargers are used to increase the amount of air drawn into the cylinders at high rpms. Turbochargers generally consist of an exhaust inlet leading to a turbine which operates an air compressor connected to the intake manifold of the engine. The heat and pressure from the engine exhaust is used to rotate the turbine which is usually inline with an air compressor on the same shaft. The air compressor, driven by the turbine and having an air intake exposed to the ambient environment, forces ambient air into the cylinders at pressures exceeding 1 atm. The increased flow of air into the cylinders improves the efficiency of combustion and this increases the power output and performance of the engine.

While turbochargers can be highly effective, too much pressure inside the cylinders can cause damage to the engine. As a result, most turbochargers will employ a safety measure to ensure that a safe pressure threshold is not exceeded. Often this involves the use of a wastegate.

A wastegate is generally a device that relieves excess pressure from the exhaust inlet to the turbine such that the intake exhaust pressure is at or below the safety threshold. In other words, the wastegate ensures that the turbocharger is able to deliver an ideal pressure to the intake manifold such that better engine performance is available to the driver.

Typical designs used to prevent the excess pressure from entering the cylinders involve external wastegates attached to a secondary exhaust line diverging from the primary exhaust line that feeds into the turbocharger. The secondary exhaust line and the wastegate relieve the excess pressure from the primary exhaust line when these pressures exceed the safety threshold of the system. The system for coupling the wastegate, turbocharger and engine exhaust lines is generally known as an exhaust coupler.

A drawback of the typical current design of the exhaust coupler is the inclusion of a secondary exhaust line which funnels exhaust from the primary exhaust line of the system. That is, in the typical exhaust coupler design, the normal flow of exhaust in the primary exhaust line leading to the turbocharger is altered. Importantly, the irregularities in the flow of exhaust leading to the turbocharger is known to adversely affect the performance of the turbocharger and ultimately of the engine.

As a result, there has been a need for improved exhaust couplers that allow for the diverging of exhaust from the primary exhaust line without causing large irregularities in the flow of the exhaust and specifically that does not substantially increase the turbulence of the airflow entering the turbocharger while a portion of the exhaust is being directed towards the wastegate. Importantly, this would allow for a more regular flow of exhaust gases into the turbocharger leading to enhanced engine performance.

### SUMMARY OF THE INVENTION

In accordance with the invention, there is provided an exhaust coupler for operative attachment between a main exhaust line of an internal combustion engine, an exhaust inlet of a turbocharger and an exhaust intake of an external wastegate. The exhaust coupler is effective in directing a portion of engine exhaust towards an external wastegate in such a way that the relative degree of turbulence within the exhaust flowing into the turbocharger is not substantially altered when exhaust flow is or is not being directed towards the wastegate.

In accordance with a first aspect, there is provided an exhaust coupler for operative attachment between a main exhaust line of an internal combustion engine, an exhaust inlet of a turbocharger and an exhaust intake of an external wastegate including: a body having first and second connecting ends for operative connection to the main exhaust line and the exhaust input of the turbocharger respectively and a bleed-flow stem for operative connection to the external wastegate; the body including a central void and a peripheral cavity between an inside wall of the body and an outside wall of an insert collar seated within the central void wherein the peripheral cavity is for releasing exhaust gas from the main exhaust line through or around the insert collar to the bleed-flow stem.

In one embodiment, the first connecting end contains a spherical seat for flexible connection to the main exhaust line.

In another embodiment, the second connecting end is for use with a flange-type connection for coupling to the exhaust inlet of a turbocharger.

In another embodiment, a bleed-flow stem is contiguous with the body for directing exhaust gas away from the central void.

In one embodiment, the bleed-flow stem includes a connector for use with a flange-type connection for coupling to the input of an external wastegate.

In another embodiment, an insert collar includes a plurality of holes to divert exhaust from the central void to the peripheral cavity.

In further embodiments, the insert collar includes a plurality of slots or slanted slots to divert exhaust from the central void to the peripheral cavity.

### BRIEF DESCRIPTION OF THE DRAWINGS

The invention is described with reference to the accompanying figures in which:

FIG. 1 is a schematic plan view of an exhaust coupler in accordance with a first embodiment of the invention;

FIG. 2 is a schematic cross section of an exhaust coupler of FIG. 1 showing the position of an insert collar in accordance with a first embodiment of the invention;

FIG. 2b is a schematic cross section of an alternative insert collar having slots along the circumference of the insert collar;

FIG. 2c is a schematic cross section of an alternative insert collar having slanted slots along the circumference of the insert collar;

FIG. 3 is a schematic cross section of an exhaust coupler of FIG. 1 showing the position of an insert collar in accordance with a second embodiment of the invention;

FIG. 4 is a schematic internal view of an exhaust coupler showing a peripheral cavity defined by the inside wall of a cylinder collar and an outside wall of an insert collar;

FIG. 5 is a schematic internal view of an exhaust coupler showing the flow of exhaust gas between the main exhaust line of an internal combustion engine and the exhaust intake of a turbocharger with an external wastegate closed; and

FIG. 6 is a schematic internal view of an exhaust coupler showing the flow of exhaust gas between the main exhaust line of an internal combustion engine and the exhaust intake of a turbocharger with an external wastegate open.

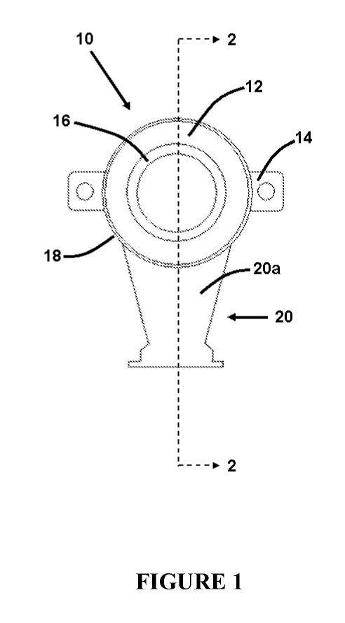

### DETAILED DESCRIPTION OF THE INVENTION

### Overview

In accordance with the invention, and with reference to the figures, an exhaust coupler 10 for a turbocharger and an external wastegate is mounted between an existing main exhaust line 32 and the exhaust inlet of a turbocharger 34. The system generally includes a collar 18 with first connection end 22 containing a spherical seat 12 for a flexible coupling to fit the main exhaust line 32 and a second connection end 24 for use with a suitable flange-type connection for coupling to the exhaust inlet of the turbocharger 34. The system also includes mounting brackets 14 contiguous with the collar, a peripheral cavity 26 spanning and extending around the circumference of the collar and defined by an insert collar 16 housed within the collar 18, and a bleed-flow stem 20 leading from the collar 18 with a connector 20a for use with a suitable flange-type connection for coupling to the input of the external wastegate 36.

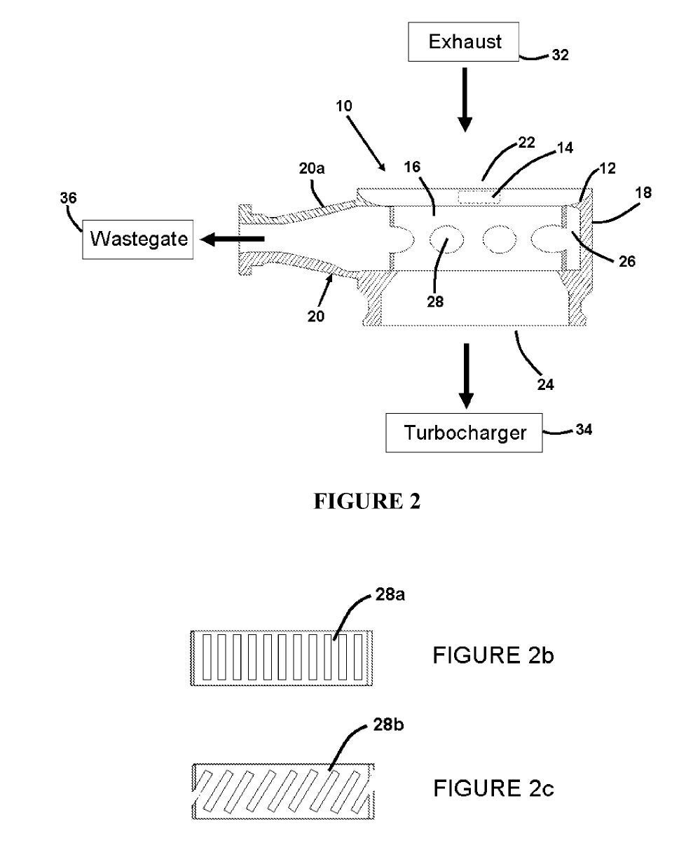

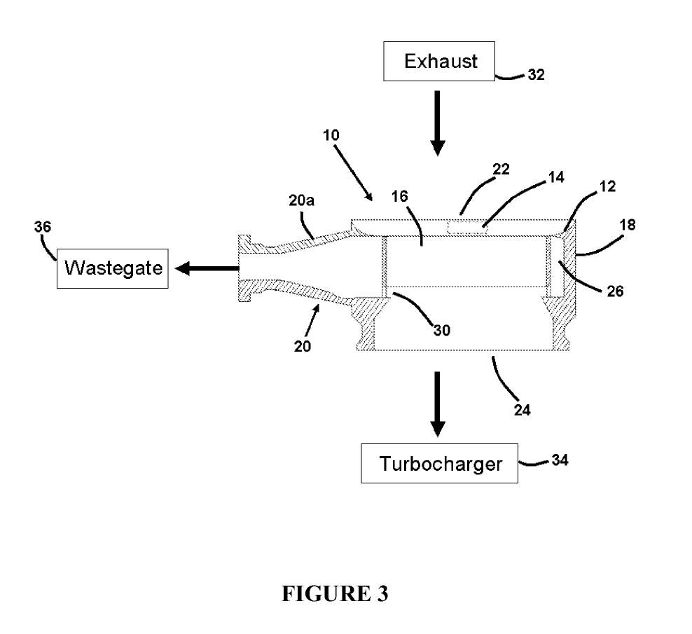

In a first embodiment, FIG. 2 illustrates an insert collar 16 having a plurality of holes 28 extending through the insert collar. In a second embodiment, FIG. 3 illustrates an insert collar that does not include holes 9 but defines a gap 30 between a lower end of the insert collar and the peripheral cavity. Further embodiments are also shown where FIGS. 2b and 2c show additional designs of the insert collar 16 which may allow for exhaust to enter the cylinder cavity 26 through vertical 28a or slanted 28b slots.

Importantly, the peripheral cavity 26 extends around the circumference of the collar 18 outside the insert collar 16. As noted, in the embodiment shown in FIG. 2, holes 28 allow the exhaust flow to enter the peripheral cavity 26 through any or all of the holes 28 and into the bleed flow stem 20. In the embodiment shown in FIG. 3, the insert collar 16 is raised above the second connection end 24 such that exhaust flow enters the cylinder cavity through the gap 30.

Preferably, the bleed-flow stem 20 is connected to the cylindrical collar 18 with a connector 20a on the opposite end for attachment to the input of the external wastegate 36. The connector 20a may be connected with a suitable flange-type connection for coupling to the input of the external wastegate 36.

### Operation

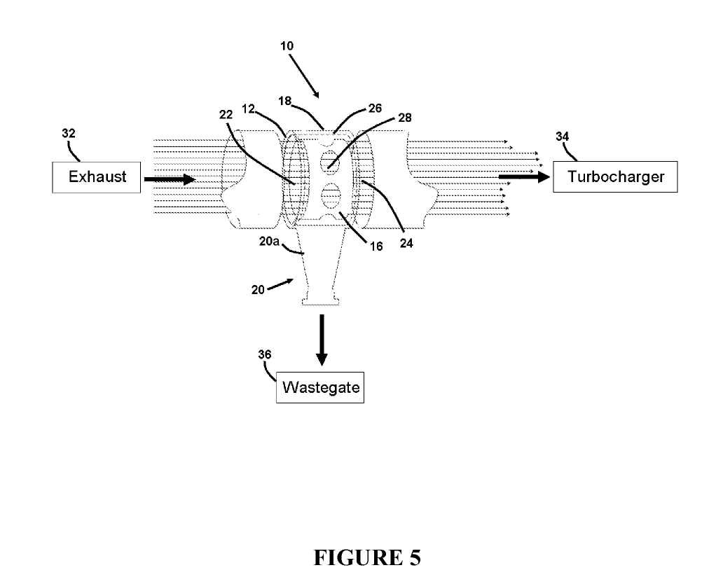

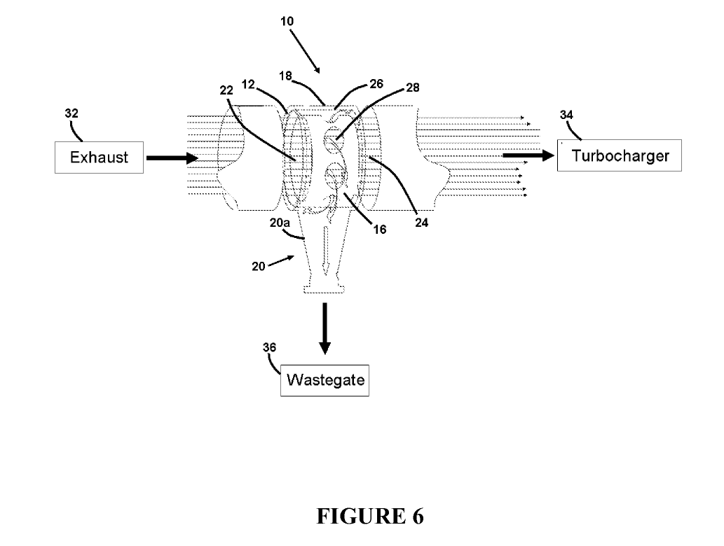

Generally, during operation of the exhaust coupler 10, exhaust gas from the engine is passed through and within the exhaust coupler as the exhaust gas flows from the main exhaust line 32 towards the exhaust inlet of a turbocharger 34. Exhaust pressure above a predefined threshold is vented from the main exhaust line 32 via the holes/slots spaced along the insert collar 16 on the inside circumference of the collar 18 as shown in FIGS. 2, 4, 5, 6 or through the void space 30 as shown in FIG. 3. The vented exhaust gas is then funnelled towards and through the bleed-flow stem 20 where it continues to exit through the external wastegate 36.

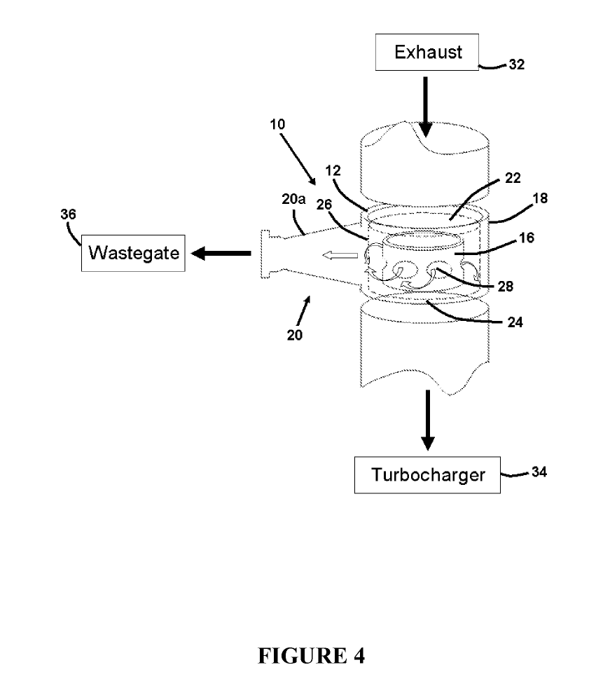

Referring to FIGS. 2 and 4, the operation of the exhaust coupler when the attached wastegate is closed is described. In this case, exhaust gas from the main exhaust line 32 enters the exhaust coupler 10 and is directed towards the turbocharger without any exhaust gas flowing through the bleed-flow stem 20. As a result of the relative size and positioning of the holes/slots/gap, exhaust flow is generally non-turbulent.

Conversely, when the pressure inside the exhaust coupler exceeds the release pressure of the wastegate, exhaust gas will be released to the bleed-flow stem 20 through the holes/slots in the insert collar or gap 30 beneath the insert collar and through the peripheral cavity 26. Importantly, due to the relative size of the holes/slots/gap, minimal turbulence is introduced into the main flow of exhaust gas into the turbocharger with the result being that the performance of the turbocharger is improved relative to a prior art exhaust coupler where the flow patterns resulting from an “unregulated” release of pressure to the wastegate will introduce flow turbulence into the turbocharger inlet.

In summary, the exhaust coupler as described is intended to minimize or reduce the turbulence in the exhaust flow entering a turbocharger when the exhaust pressure is being released by an associated wastegate.

Moreover, while the invention has been described by the foregoing description, it is understood that various modifications to the representative embodiments described herein may be made without departing from the spirit of the invention as understood by those skilled in the art.

1. An exhaust coupler for operative attachment between a main exhaust line of an internal combustion engine, an exhaust inlet of a turbocharger and an exhaust intake of an external wastegate, the exhaust coupler comprising:
a body having a first connecting end for operative connection to the main exhaust line, a second connecting end for operative connection to the exhaust input of the turbocharger, and a bleed-flow stem for operative connection to the external wastegate, the body having;
a central void and a peripheral cavity between an inside wall of the body and an outside wall of an insert collar seated within the central void
wherein the peripheral cavity is for releasing exhaust gas from the main exhaust line through or around the insert collar to the bleed-flow stem.

2. An exhaust coupler as in claim 1 wherein the insert collar includes a plurality of holes to divert exhaust from the central void to the peripheral cavity.

3. An exhaust coupler as in claim 1 wherein the insert collar includes a plurality of slots to divert exhaust from the central void to the peripheral cavity.

4. An exhaust coupler as in claim 1 wherein the insert collar includes a plurality of slanted slots to divert exhaust from the central void to the peripheral cavity.

5. An exhaust coupler as in claim 2 wherein the insert collar includes a plurality of slots to divert exhaust from the central void to the peripheral cavity.

6. An exhaust coupler as in claim 2 wherein the insert collar includes a plurality of slanted slots to divert exhaust from the central void to the peripheral cavity.

7. An exhaust coupler as in claim 3 wherein the insert collar includes a plurality of slanted slots to divert exhaust from the central void to the peripheral cavity.

8. An exhaust coupler as in claim 2 wherein the bleed-flow stem includes a connector for use with a flange-type connection for coupling to the input of the external wastegate.

9. An exhaust coupler as in claim 3 wherein the bleed-flow stem includes a connector for use with a flange-type connection for coupling to the input of the external wastegate.

10. An exhaust coupler as in claim 4 wherein the bleed-flow stem includes a connector for use with a flange-type connection for coupling to the input of the external wastegate.

11. An exhaust coupler as in claim 1 wherein the first connecting end contains a spherical seat for flexible connection to the main exhaust line.

12. An exhaust coupler as in claim 1 wherein the second connecting end is for use with a flange-type connection for coupling to the exhaust inlet of the turbocharger.
